(19) United States
(12) Patent Application Publication
(10) Pub. No.: US 2006/0164577 A1
(43) Pub. Date: Jul. 27, 2006

(54) One-way transparent optical system, flat panel display having the same, and method of fabricating the one-way transparent optical system

(75) Inventors: Hyung-taek Lim, Seoul (KR); Hyung Choi, Seongnam-si (KR); Byoung-ho Cheong, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/296,331

(22) Filed: Dec. 8, 2005

(30) Foreign Application Priority Data
Jan. 22, 2005 (KR) 10-2005-0006086

(51) Int. Cl. G02F 1/1335

(52) U.S. Cl. 349/114

(57) ABSTRACT

A one-way transparent optical system and a flat panel display having the same are provided. The one-way transparent optical system includes a transparent substrate and an external light blocking layer. The external light block layer includes: first light reflecting layers, first and second light reflecting layers, transmitting windows, and first and second light absorbing layers. The first light reflecting layers are formed on and inclined toward the transparent substrate. The second light reflecting layers are spaced a predetermined distance from the first light reflecting layers. The first and second light reflecting layers are alternately arranged on the transparent substrate. The transmitting windows are formed in the upper and lower portions of the spaces between the first and second light reflecting layers. The first and second light absorbing layers respectively formed on the first and second light reflecting layers.

### CROSS-REFERENCE TO RELATED PATENT APPLICATION

This application claims priority from Korean Patent Application No. 10-2005-006086, filed on Jan. 22, 2005, in the Korean Intellectual Property Office, the disclosure of which is incorporated herein in its entirety by reference.

### BACKGROUND OF THE INVENTION

1. Field of the Invention

The present invention relates to a one-way transparent optical system capable of preventing effulgence and, more particularly, to a one-way transparent optical system, a flat panel display, and a method of fabricating the one-way transparent optical system capable of effectively blocking external light and externally transmitting almost all of internal light.

2. Description of the Related Art

Flat panel displays are divided into an electroluminescence device, a liquid crystal display device (LCD), a plasma display panel (PDP), and a field emission display (FED).

However, when a direct illumination-type device, such as an organic electroluminescence (EL) device is used, not only is external light reflected from the surface of the display device causing effulgence, but contrast is also reduced due to metal electrodes on the inside reflecting and absorbing internal light. To prevent these problems, the prior art shown in FIG. 1 uses a non-reflective coating and a polarizing plate and a quarter-wavelength plate. Specifically, the display device uses a non-reflective coating to minimize effulgence caused by external light 20 reflecting from the surface of the display device. Also, by forming the polarizing plate 12 and the quarter-wavelength plate 11 on the surface of the display device, the device prevents external light that has already entered from being reflected back, thereby solving the contrast reduction problem. That is, the external light 20 that passes through the polarizing plate 12 has only a linearly polarized component, as shown in FIG. 1. Because the polarization of the external light 20 having only the linearly polarized component changes to a circular polarization by means of the quarter-wavelength plate 11, the light will not pass through the polarizing plate when it is reflected. Accordingly, light that enters from the outside is prevented from being emitted again.

However, according to the prior art method, emission of the internal light as well as the external light is suppressed by the quarter-wavelength plate 11 and the polarizing plate 12, so that less than 50% of the internal light can be emitted from the inside of the display device to the outside. Therefore, the method for preventing effulgence and contrast reduction of the prior art also causes a reduction in light efficiency and brightness of the display device.

An organic EL device having a structure reducing effulgence that uses light absorbing materials instead of a polarizing plate is shown in FIG. 2. As shown in FIG. 2, a first electrode 22, a hole injection layer 23, a hole transport layer 24, an organic light-emitting layer 25, an electron transport layer 26, an electron injection layer 28, and a second electrode 29 are sequentially stacked on the transparent substrate 21 of the organic EL device. Here, the electron transport layer 26 is doped with a light absorbing material. However, because the light absorbing material of this layout also absorbs the inside light emitted by the organic EL 25 device, the only benefit is a reduction in manufacturing cost compared to the polarizing plate layout.

FIG. 3 illustrates a method of reducing effulgence by using destructive interference. The display device in FIG. 3 has a first electrode 31, a light-emitting layer 32, a second electrode 33, a top protective layer 34, and a non-reflective coating 35 that are sequentially stacked. Also, the first electrode includes a semi-transmissive layer 31a, a transmission layer 31b, and a total reflection layer 31c. In this layout, a portion of the external light L1 is not reflected, but absorbed by the non-reflective coating 35. From the light L2 and L3 that permeates the non-reflective coating 35, L2 is reflected by the semi-transmissive layer 31a, and the remaining L3 is reflected by the total reflection layer 31c. Here, the light L2 that is reflected by the semi-transmissive layer 31a and the light L3 that is reflected by the total reflection layer 31c mutually interfere, destroying each other. However, even with this method, since a portion of the internal light from the light-emitting layer 32 is reflected by the semi-transmissive layer 31a and the total reflection layer 31c, to mutually interfere and destroy each other, the contrast of the display device is deteriorated.

### SUMMARY OF THE INVENTION

The present invention provides a one-way transparent optical system and a flat panel display comprising the same capable of solving the low contrast problems by effectively blocking external light and transmitting substantially all of the internal light.

The present invention also provides a method for fabricating the one-way transparent optical system, whose manufacturing process is simple and that can be applied to mass production.

According to an aspect of the present invention, there is provided a one-way transparent optical system including a transparent substrate and an external light blocking layer. The external blocking layer has: first light reflecting layers formed on the transparent substrate and inclined toward the transparent substrate and second light reflecting layers spaced a predetermined distance from the first light reflecting layers, the first and second light reflecting layers being alternately arranged on the transparent substrate; transmitting windows formed in upper and lower portions of spaces between the first and second light reflecting layers; and first and second light absorbing layers respectively formed on the first and second light reflecting layers.

The first and second light reflecting layers and the first and second light absorbing layers may be formed with curved surfaces.

The first and second light reflecting layers and the first and second light absorbing layers may be one of spherical and aspherical surfaces.

The first and second light reflecting layers, and the first and second light absorbing layers are one of concave and convex toward the transparent substrate.

The first and second light reflecting layers and the first and second light absorbing layers have flat surfaces.

The first and second light absorbing layers may be made of at least one of Cr/CrO, carbon black, iron oxide, black colorant, Fe₃O₄, or Fe₂O₃—Mn₂O₃.

The first and second light reflecting layers may be arranged symmetrically with respect to a vertical axis of the transparent substrate.

According to another aspect of the present invention, there is provided a flat panel display including: a first electrode; a light-emitting layer formed on the first electrode; a second electrode made of a light transmitting material formed on the light-emitting layer; a transparent substrate formed on the second electrode; and an external light blocking layer comprising first light reflecting layers formed on the transparent substrate and inclined toward the transparent substrate, second light reflecting layers alternately arranged and spaced at a predetermined distance from the first light reflecting layers, transmitting windows formed at tops and bottoms of the spaces between the first and adjacent second light reflecting layers, and first and second light absorbing layers formed respectively on the first and second light reflecting layers.

According to a further aspect of the present invention, there is provided a flat panel display including: a first polarizing plate; a first substrate having a thin film transistor array and pixel electrodes, formed on the first polarizing plate; a second substrate having a common electrode; a liquid crystal layer formed between the first and second substrates; a second polarizing plate formed on the second substrate; a transparent substrate formed on the second polarizing plate; an external light blocking layer comprising first light reflecting layers formed on the transparent substrate and inclined toward the transparent substrate, second light reflecting layers alternately arranged and spaced at a predetermined distance from the first light reflecting layers, transmitting windows formed at tops and bottoms of the spaces between the first and adjacent second light reflecting layers, and first and second light absorbing layers formed respectively on the first and second light reflecting layers.

According to another aspect of the present invention, there is provided a method of manufacturing a one-way transparent optical system, comprising: a) coating a transparent material on a first transparent substrate; b) patterning the transparent material by etching; c) forming a plurality of grooves through patterning, and stacking a light absorbing layer and a light reflecting layer on the grooves; d) coating a transparent material over the light reflecting layer; e) laminating the transparent material of step (d) until the top portions of the light reflecting layer are removed and thereafter stacking a second transparent substrate thereon; f) removing the first transparent substrate so as to expose at least a portion of the light absorbing layer; and g) laminating the transparent material until the top portions of the light absorbing layer are removed.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic sectional view of a portion of a flat panel display device of the prior art for preventing effulgence;

FIG. 2 is a schematic sectional view of an organic electroluminescence display device (OELD) of the prior art for preventing effulgence, that uses a light absorbing material;

FIG. 3 is a schematic sectional view of a prior art OELD having an effulgence prevention structure that uses destructive interference;

FIG. 4 is a schematic sectional view of a flat panel display device having a one-way transparent optical system according to an exemplary embodiment of the present invention;

FIGS. 5A and 5B are sectional views of a one-way transparent optical system according to exemplary embodiments of the present invention;

FIG. 6 is a sectional view of an example of a one-way transparent optical system employed in an LCD; and

FIGS. 7A through 7H are sectional views of a method of fabricating a one-way transparent optical system according to the present invention.

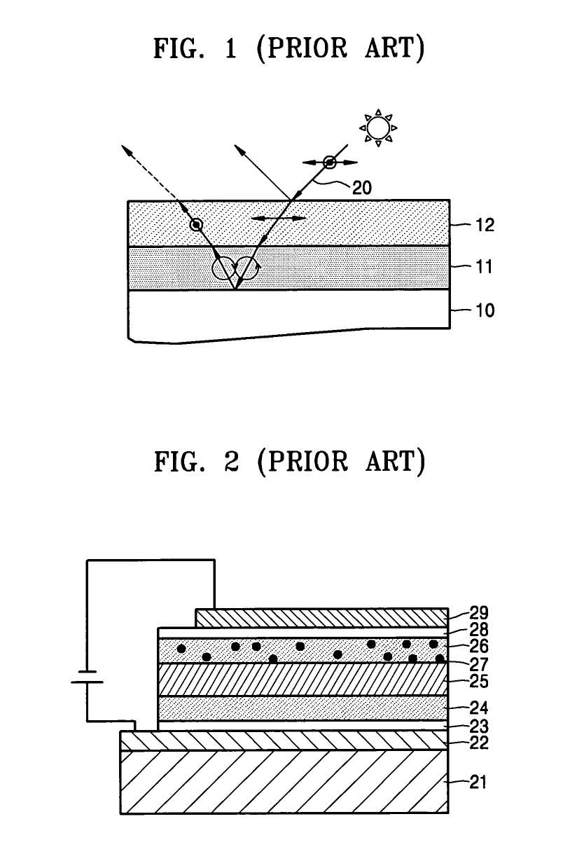

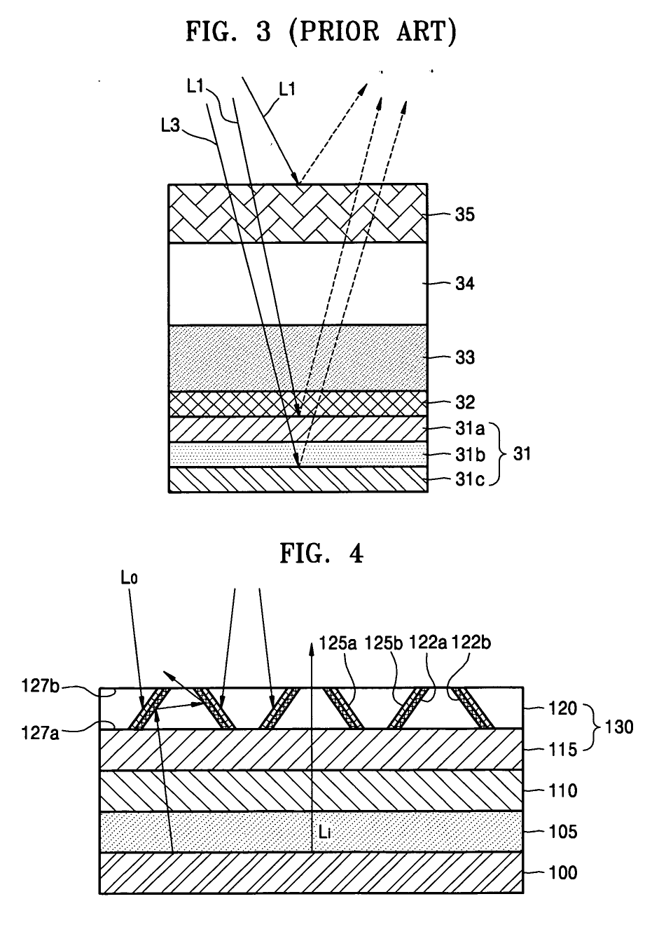

### DETAILED DESCRIPTION OF ILLUSTRATIVE, NON-LIMITING EMBODIMENTS OF THE INVENTION

Referring to FIG. 4, the one-way transparent optical system 130 of the present invention includes a transparent substrate 115 and an external light blocking layer 120 formed above the transparent substrate 115. The one-way transparent optical system 130 is made in film form, and can thus be easily attached to a flat panel display. The flat panel display in FIG. 4 is an organic electroluminescence device (OELD), and includes a first electrode 100, a second electrode 110, and a light-emitting layer 105 between the first and second electrodes 100 and 110. When a forward current is supplied to the organic illuminating material of an OELD, electrons and holes pass through a P-N juncture region between a hole provision layer and an electron provision layer and recombine. Since the electrons and holes have a lower energy when they recombine than when they are apart from each other, light is emitted from the OELD by the energy difference generated. Moreover, if a voltage is applied to the first electrode 100 and the second electrode 110, the electrons and the holes in the light-emitting layer 105 recombine and emit light.

On the other hand, in order to effectively block external light from entering a flat panel display as well as prevent a decrease in a rate of emission of interior light (Li), first and second light reflecting layers 122a and 122b are alternately arranged inside the external light blocking layer 120; and first and second light absorbing layers 125a and 125b are respectively formed on the first and second light reflecting layers 122a and 122b.

The first light reflecting layers 122a are inclined toward the transparent substrate 115, the second light reflecting layers 122b are formed alternately and spaced a predetermined distance from the first light reflecting layers 122a, and first and second transmitting windows 127b and 127a are respectively formed in the upper and lower portions of the spaces between the first and second light reflecting layers 122a and 122b. The first and second light reflecting layers 122a and 122b are arranged symmetrically with respect to a vertical axis of the transparent substrate 115.

In addition, the first and second light absorbing layers 125a and 125b are respectively formed on the first and second light reflecting layers 122a and 122b to absorb external light (Lo). The first and second light absorbing layers are made of Cr/CrO, carbon black, iron oxide, black colorant, Fe₃O₄, or Fe₂O₃—Mn₂O₃.

The first and second light reflecting layers 122a and 122b can have flat or curved surfaces. FIG. 4 shows the first and second light reflecting layers 122a and 122b having flat surfaces. The first and second light absorbing layers 125a and 125b have the same shapes of the first and second light reflecting layers 122a and 122b.

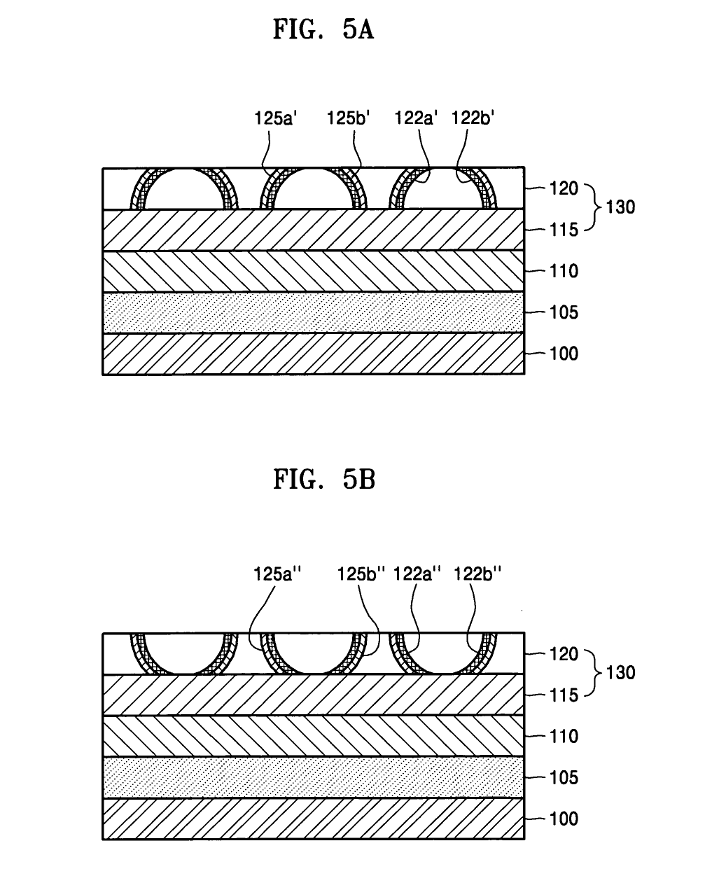

As shown in FIG. 5A, first and second light reflecting layers 122a′ and 122b′, having curved surfaces, can be convex toward the transparent substrate 115; or first and second light reflecting layers 122a″ and 122b″ can be concave toward the transparent substrate, as shown in FIG. 5B. The first and second light reflecting layers 122a″ and 122b″ can be spherical or aspherical if they are curved.

The light emitted from the light-emitting layer 105 is emitted to the outside after passing through the second electrode 110, the transparent substrate 115, and the first and second transmitting windows 127a and 127b, or after being multiply reflected by the first and second light reflecting layers. Meanwhile, the reflection of external light (Lo) to the outside can be prevented by the first and second light absorbing layers 125a and 125b absorbing the external light (Lo).

The one-way transparent optical system thus allows the light emitted from the inside of the flat panel display to be effectively released to the outside and suppresses effulgence by preventing the external light from being reflected to the outside.

The one-way transparent optical system of the present invention can apply, not only to an OELD, but also to an LCD.

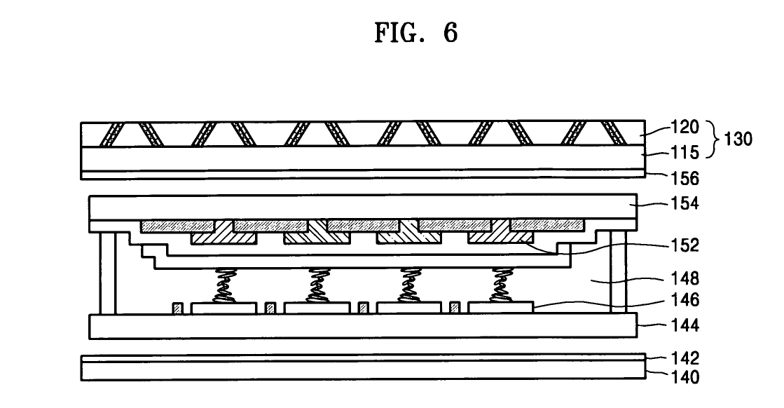

FIG. 6 is a sectional view of an example of a one-way transparent optical system employed in an LCD. The LCD has a first polarizing plate 142, a first substrate 144, a second substrate 154, and a liquid crystal layer 148 between the first and second substrates 144 and 154. A backlight disposed below the first polarizing plate 142 emits light. The first substrate 144 has pixel electrodes 146, and the second substrate 154 has a common electrode 152. When a voltage is applied to the common electrode 152 and the pixel electrodes 146, arrangement of the molecules in the liquid crystal layer 148 changes and the transmittance changes in each pixel unit, so that an image is formed.

The one-way transparent optical system 130 of the present invention is attached to the top of the second polarizing plate 120. Since the one-way transparent optical system 130 is the same as that in the above description, detailed description thereof will be omitted. The one-way transparent optical system 130 of the present invention, being able to effectively prevent a reduction of internal light emitted from the display and effulgence caused by the reflection of external light, can be applied to a variety of flat panel displays.

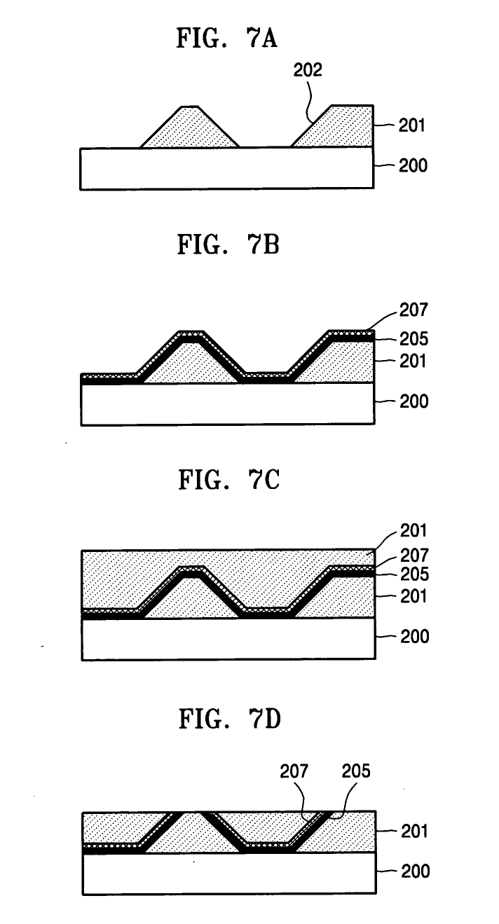

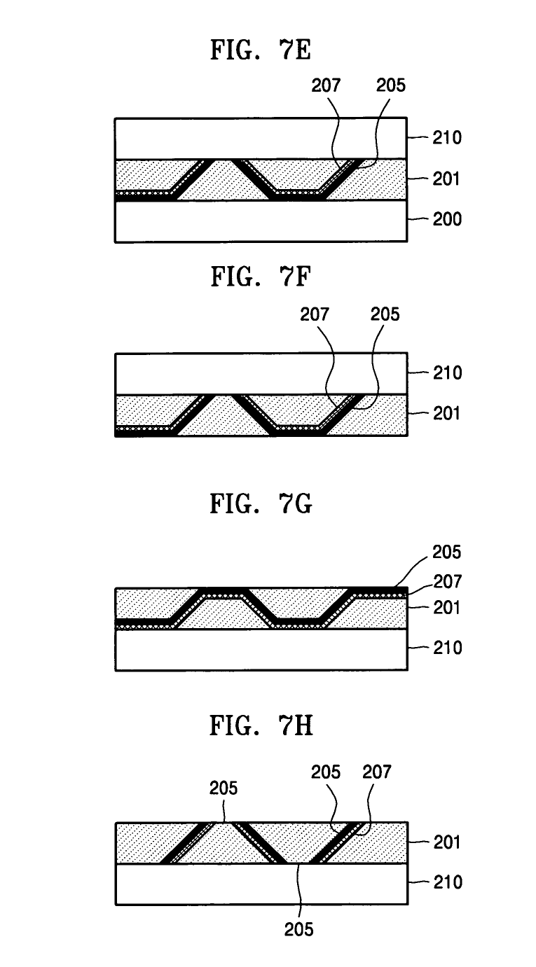

Next, a process of manufacturing a one-way transparent optical system of the present invention will be described. Referring to FIG. 7A, a transparent material 201 is coated on the first transparent substrate 200, and the coated layer is patterned by etching. A plurality of grooves 202 are formed through patterning, and a light absorbing layer 205 and a light reflecting layer 207 are stacked on the grooved surface, as shown in FIG. 7B. Then, a transparent material 201 is coated over the light reflecting layer 207, as shown in FIG. 7C; and the transparent material 201 is laminated until the top portions of the light reflecting layers 207 are removed, as shown in FIG. 7D. After the top portions of the light reflecting layers 207 are removed, a second transparent substrate 210 is stacked thereupon, as shown in FIG. 7E. Thereafter, the first transparent substrate 200 is removed, as shown in FIG. 7F. FIG. 7G is a reversal of FIG. 7F, for convenience. Then, the transparent material 201 layer is laminated until the top portions of the light absorbing layers 205 are removed, as shown in FIG. 7H. Light transmitting windows 215 are thus created in the spaces between neighboring the light absorbing layers 205 and neighboring the light reflecting layers 207.

The outside light blocking layer of the one-way transparent optical system of the present invention, having the light reflecting layers and the light absorbing layers, can be easily manufactured through a photolithography method, using a dry etching process that makes the mass-production, mass-production of a large area, and fine process possible.

The one-way transparent optical system of the present invention and the flat panel displays adopting the same allow the light emitted from the inside of the flat panel display to be emitted to the outside through the light reflecting layers with virtually no loss of luminance and prevents the external light from being reflected back to the outside by absorbing the light using the light absorbing layers.

In addition, since the one-way transparent optical system is manufactured in film form, it can be applied to a variety of flat panel displays, and does not require complex installation processes when being installed on the flat panel display devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A one-way transparent optical system comprising:
a transparent substrate; and
an external light blocking layer comprising first light reflecting layers formed on the transparent substrate and inclined toward the transparent substrate, second light reflecting layers alternately arranged and spaced at a predetermined distance from the first light reflecting layers, transmitting windows formed at tops and bottoms of spaces between the first and adjacent second light reflecting layers, and first and second light absorbing layers formed respectively on the first and second light reflecting layers.

2. The optical system of claim 1, wherein the first and second light reflecting layers and the first and second light absorbing layers have curved surfaces.

3. The optical system of claim 2, wherein the first and second light reflecting layers and the first and second light absorbing layers have one of spherical and aspherical surfaces.

4. The optical system of claim 1, wherein the first and second light reflecting layers and the first and second light absorbing layers are one of concave and convex toward the transparent substrate.

5. The optical system of claim 1, wherein the first and second light reflecting layers and the first and second light absorbing layers have flat surfaces.

6. The optical system of claim 1, wherein the first and second light absorbing layers are made of at least one of Cr/CrO, carbon black, iron oxide, black dye, Fe₃O₄, and Fe₂O₃—Mn₂O₃.

7. The optical system of claim 1, wherein the first and second light reflecting layers are arranged symmetrically with respect to a vertical axis of the transparent substrate.

8. A flat panel display comprising,
a first electrode;
a light-emitting layer formed on the first electrode;
a second electrode made of a light transmitting material and formed on the light-emitting layer;
a transparent substrate formed on the second electrode; and
an external light blocking layer comprising first light reflecting layers formed on the transparent substrate and inclined toward the transparent substrate, second light reflecting layers alternately arranged and spaced at a predetermined distance from the first light reflecting layers, transmitting windows formed at tops and bottoms of the spaces between the first and adjacent second light reflecting layers, and first and second light absorbing layers formed respectively on the first and second light reflecting layers.

9. The flat panel display of claim 8, wherein the first and second light reflecting layers and the first and second light absorbing layers have curved surfaces.

10. The flat panel display of claim 9, wherein the first and second light reflecting layers and the first and second light absorbing layers have one of spherical and aspherical surfaces.

11. The flat panel display of claim 8, wherein the first and second light reflecting layers, and the first and second light absorbing layers are one of concave and convex toward the transparent substrate.

12. The flat panel display of claim 8, wherein the first and second light reflecting layers and the first and second light absorbing layers have flat surfaces.

13. The flat panel display of claim 8, wherein the first and second light absorbing layers are made of at least one of Cr/CrO, carbon black, iron oxide, black dye, Fe₃O₄, and Fe₂O₃—Mn₂O₃.

14. The flat panel display of claim 8, wherein the light-emitting layer is an organic electroluminescence layer.

15. The flat panel display of claim 8, wherein the first and second light reflecting layers are arranged symmetrically with respect to a vertical axis of the transparent substrate.

16. A flat panel display comprising:
a first polarizing plate;
a first substrate having a thin film transistor array and pixel electrodes, formed on the first polarizing plate;
a second substrate having a common electrode;
a liquid crystal layer formed between the first and second substrates;
a second polarizing plate formed on the second substrate;
a transparent substrate formed on the second polarizing plate; and
an external light blocking layer comprising first light reflecting layers formed on the transparent substrate and inclined toward the transparent substrate, second light reflecting layers alternately arranged and spaced at a predetermined distance from the first light reflecting layers, transmitting windows formed at tops and bottoms of the spaces between the first and adjacent second light reflecting layers, and first and second light absorbing layers formed respectively on the first and second light reflecting layers.

17. A method of manufacturing a one-way transparent optical system, comprising:
a) coating a transparent material on a first transparent substrate;
b) patterning the transparent material by etching;
c) forming a plurality of grooves through patterning, and stacking a light absorbing layer and a light reflecting layer on the grooves;
d) coating a transparent material over the light reflecting layer;
e) laminating the transparent material of step (d) until the top portions of the light reflecting layer are removed and thereafter stacking a second transparent substrate thereon;
f) removing the first transparent substrate so as to expose at least a portion of the light absorbing layer; and
g) laminating the transparent material until the top portions of the light absorbing layer are removed.
